(19) United States
(12) Patent Application Publication
(10) Pub. No.: US 2005/0105685 A1
(43) Pub. Date: May 19, 2005

(54) Simultaneous multifocal coherent x-ray scanning (cxrs)

(75) Inventor: Geoffrey Harding, Hamburg (DE)

Correspondence Address: SQUIRE, SANDERS & DEMPSEY L.L.P, 600 HANSEN WAY, PALO ALTO, CA, 94304-1043, US

(73) Assignee: YXLON International Security Gmbh, Hamburg (DE)

(21) Appl. No.: 10/504,115

(22) PCT Filed: Feb. 26, 2003
(86) PCT No.: PCT/EP03/01969

(30) Foreign Application Priority Data
Feb. 26, 2002 (EP) 02004153.9

(51) Int. Cl. G01N 23/201

(52) U.S. Cl. 378/86

(57) ABSTRACT

The invention relates to a system for measuring the pulse transmission spectrum of X-ray quanta that are elastically scattered in an examination zone for containers according to the preamble of claim 1. Corresponding systems that are based on the principle of examination with coherent scattered radiation are known from the prior art and from our previous application EP 11 06 227. These systems are problematic in that the electronic system required for controlling the X-ray capacity of the different focal points is too complicated and the measuring time is relatively long as only one focus is active at a time. This results in a low detection efficiency as the voxel geometry allows for non-scanned areas so that objects looked for in the container can be overlooked. The invention is based on the surprising finding that these problems can be overcome when the detector arrangement (D) has a two-dimensional segmenting in the Y, Z plane and lies before the Z axis and that the X-ray emitter (Q) is disposed with an elongated anode that emits radiation across its surface either completely or partially at the same time. The secondary antiscatter grid (S) runs in the Y direction converging to O and in the Z direction about the angle θ to the X axis in such a manner that Y and X of the scattered voxel in the container are coded onto the Y and Z dimensions of the detector arrangement (D) and that the primary antiscatter grid (P) and the X-ray emitter (Q) run in a cylindrically symmetrical orientation about the Z axis or in a linear/parallel orientation to the Y axis in the X,Y plane.

The invention relates to a system as recited in the preamble of claim 1 for measuring the pulse transmission spectrum of X-ray quanta that are elastically scattered in an examination region for containers.

Systems of this kind are known, for example, from EP-B1 360 347 and from EP-A1-0 556 887.

An earlier unpublished EP application 11 06 227.0 describes such a system which is based on the principle of inspections using coherent scattered radiation (Coherent X-Ray Scanning, CXRS) and which has a multi-focus X-ray emitter having an array of foci, each of which must be addressed successively using electronics to completely scan a 2-D section of a container or baggage item. To this end, it is necessary to control the X-ray power of the different foci, which requires a relatively high degree of complexity in terms of electronics. A further disadvantage is that only one focus is active at any one time, which lengthens the measuring time.

It is therefore an object of the invention to eliminate the need for electronic control of the focus position so as to simplify the high-voltage electronics as a whole and to further increase the scanning speed, or, in the case of constant/maintained measuring speed, to improve the quality of detection in order to reduce the risk of overlooking searched objects in the container.

This objective is achieved by the system characterized in claim 1.

According to the invention, a converging 2-D multi-channel scatter collimator or a secondary diaphragm arrangement is provided between the container and the detector, the 2-D multi-channel scatter collimator or secondary diaphragm arrangement encoding the Y- and X-coordinates of the scattering voxel onto the Y- and Z-dimensions of the detector. The scattered beams from different depths (X-direction) in the container are encoded onto the Y-dimension of the detector and, at the same time, the scattered beams from different focus positions (Y-direction) at the X-ray source are encoded onto the y-dimension of the detector. For this purpose, the detector array features a pixel-like segmentation, which can typically include 16 or 32×14 segments.

Thus, it is unnecessary to control the focus position electronically. In fact, the entire, advantageously cooled anode or parts thereof can simultaneously emit beams of radiation, which considerably simplifies the electrode and improves the measuring speed, that is, significantly reduces the scanning time. The total length of the system according to the invention is also reduced, making it more space-saving.

As is known, the output signals of the detector elements can be processed in a manner as described, in particular, in German Patent Application P 41 01 544.4. Suffice it to say that for each detector element, a processing channel is provided in which the signal is amplified, digitized, and fed to a pulse height analyzer that records the number of X-ray quanta in the different energy ranges. For each detector element and for each energy range, this-number is divided by the number of X-ray quanta which have been recorded for the respective energy range with the aid of the central detector element D₀. This yields the energy spectrum for each detector element, and in fact independently of the energy distribution of the X-ray quanta emitted by the X-ray emitter and largely independently of the attenuation of the scattered radiation by the object.

For a better understanding, the invention will be described in greater detail in the light of different embodiments and aspects with reference to the drawing, without being limited thereto.

In the drawing,

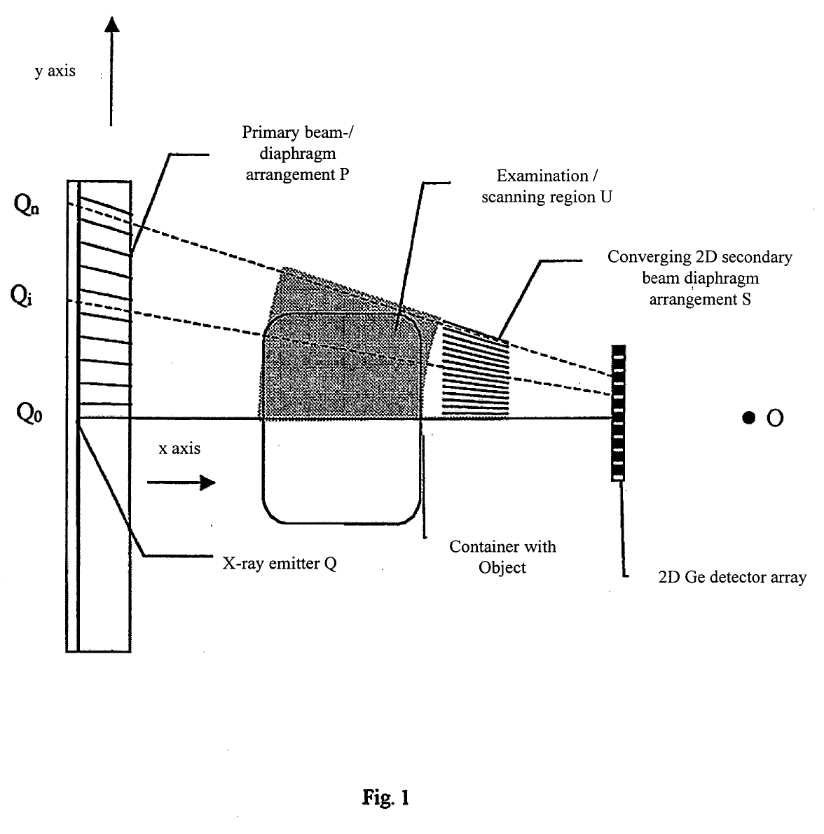

FIG. 1 shows a schematic cross-section of the scanning principle of the simultaneous multi-focus CXRS system according to the invention in the X,Y-plane;

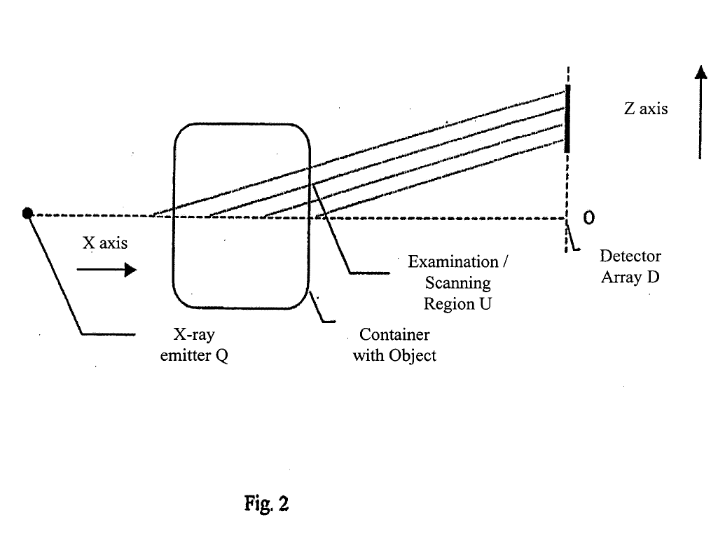

FIG. 2 shows the system of FIG. 1 in a schematic geometric representation in the X,Z-plane;

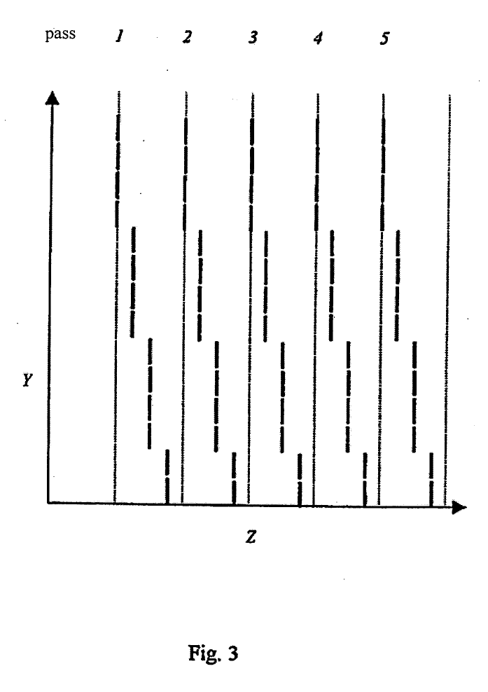

FIG. 3 shows a schematic representation of the voxel shape and distribution for the simultaneous multi-focus CXRS system according to the invention containing four segments;

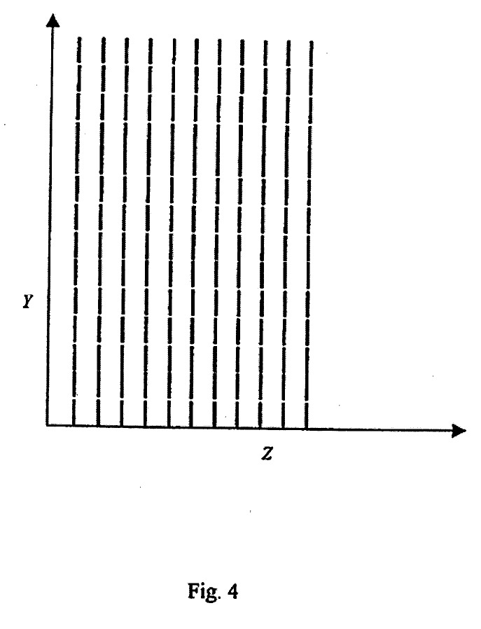

FIG. 4 shows a schematic representation of the voxel shape and distribution for the simultaneous multi-focus CXRS system according to the invention containing 32 segments;

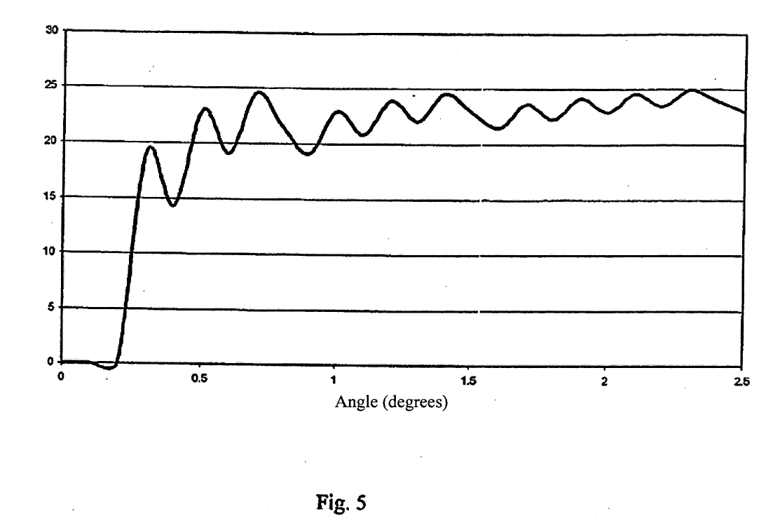

FIG. 5 is a graphical representation of the effective thickness of the scatter collimator (only on the X-axis) for selection of the X-ray emitter segment (angle in degrees on the X-axis); and

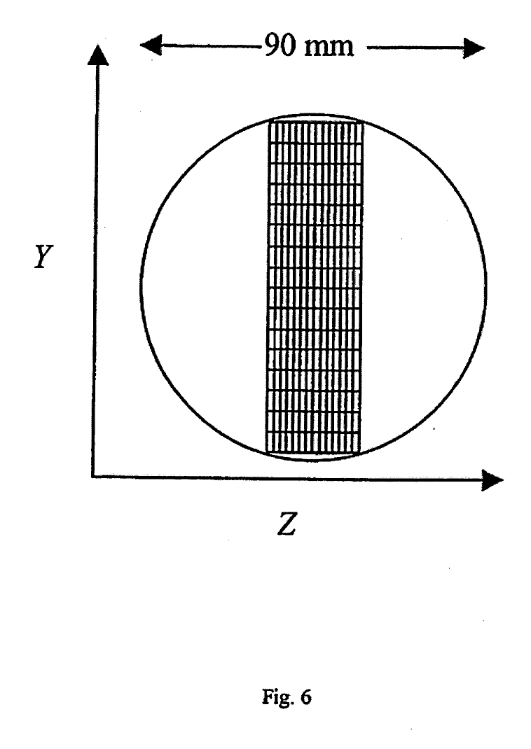

FIG. 6 shows the segmentation of the detector array used according to the invention in a schematic representation in the Y,Z-plane with measurements given in mm.

From FIG. 1, it can be seen that the system according to the invention is identical to the older system with respect to primary collimator P. As before, all beams emitted by the radiation source Q converge at point O, which, however, is now no longer physically present. A multi-channel scatter collimator is arranged between the object in examination region U and detector array D in such a manner that the scattered beams from different layers (X-direction) of the object are imaged onto different elements of detector array D in the Z-direction. At the same time, the scattered beams belonging to different focus positions (Y-direction) of radiation source/X-ray emitter Q are imaged onto different regions of detector array D in the Y-direction. According to the invention, detector array D has a two-dimensional segmentation (see below). The depth information can be encoded in the Z-direction because the scattered beams are measured at a constant scattering angle θ. This is shown in FIG. 2. The imaging is described by the following relationship:

$${Z}_{det} = \frac{tan ( θ )}{( {Q}_{0} {X}_{det} - {Q}_{0} S )} \qquad ( 1 )$$

In equation 1, Z_{det} is the distance of the scanning plane from the detector segment that receives scattered radiation at angle θ from a scattering point located at a distance Q₀S from the source, the distance of detector array D from the source being Q₀X_{det}. The imaging of the focus position onto the Y-direction of detector array D is admissible because of the arrangement of primary collimator P, which only emits radiation that converges at point O, in combination with the scatter collimator, which also has point O as the focus position. The imaging relation between the Y coordinate of the focus position, F_{source}Y and the Y direction of the detector, Y_{det}, is:

$${F}_{source} Y = {Y}_{det} \frac{{Q}_{0} O}{( {Q}_{0} O - {Q}_{0} {X}_{det} )} \qquad ( 2 )$$

The symbols have the same meaning as in equation 1 except for Q₀O, which constitutes the distance of detector array D, along the x-axis, from the plane in which X-ray emitter source Q is located.

According to the invention, it is now possible to identify the region of radiation source Q that is necessary for producing a certain scattering signal, because now there is a clear relationship between the region of the radiation source and the y-coordinate of detector array D, as described in equation 2.

Now that the basic principle of the simultaneous multi-focus CXRS arrangement according to the invention has been described, the inventive features and individual components of this arrangement will be discussed in the following, without the invention being limited thereto.

The radiation source or X-ray emitter Q benefits directly from the simultaneous multi-focus CXRS system, because now it is no longer necessary to activate individual positions; all positions of X-ray source Q can be active simultaneously. However, the prerequisite for this is that all 32 source segments must be imaged onto 32 individual detector segments in the Y-direction according to equation 2, which however, is not a necessary but only an advantageous condition. It is only required that the number of scanning cycles per scanned layer multiplied by the number of detector segments be equal to the number of source segments. Therefore, detector array D does not necessarily have to have the same number of segments as the X-ray source. The required switching sequences for the X-ray source will be discussed in the following.

By way of example, it is assumed that only 4 detector elements are available in the Y-direction of segmented detector array D, which can be the case due to the size of the detector or for reasons of cost. As shown in Table 1, detector segment 1 receives scattered radiation from sources Q1, Q5, etc., while detector segment 2 records radiation from sources Q2, Q6, etc.

TABLE 1

| | |
|---|---|
| Segment#1: | Q1, Q5, Q9, Q13, Q17, Q21, Q25, Q29 |
| Segment#2: | Q2, Q6Q30 |
| Segment#2: | Q3, Q7Q31 |
| Segment#2: | Q4, Q8Q32 |

In this case, therefore, the total measuring time is reduced by a factor of 4. The shape and position of the voxels that correspond to the above switching sequence are shown in FIG. 3. Since four source segments are active in parallel, it is possible to simultaneously measure four voxels in the object, for example, a suitcase. From this it is clear that the detector segmentation results in a greater density of measured data in the object. Alternative switching sequences for the scanning can also be found for other segmentations of detector array D correspondingly. Of course, the optimum is achieved when detector array D has a sufficient number of elements so that each X-ray source is uniquely associated with one detector element. Then, all X-ray sources are active simultaneously. For this optimum case, the spatial distribution of the scattering voxels is shown in FIG. 4.

In contrast to the older concept of “multi-focus CXRS”, in the “simultaneous multi-focus CXRS system” according to the invention, several segments of radiation source Q are active simultaneously. With this, the total measuring time for an object can only be further reduced if the power of radiation source Q does not have to be reduced even when segments of X-ray emitter Q are active simultaneously. In the older concept, it was shown that, when assessed in a conservative manner, the X-ray tube can be operated at temperatures that corresponds to a continuous-wave electron beam power of 50 kW per segment if each segment is activated only for 500 μs, it being assumed that the actual (not the projected) size of the focus has a length of about 50 mm (in the Y-direction) and a width of 1 mm (in the Z-direction).

The load capacity (power capacity) of an X-ray tube having a stationary anode and an elliptically-shaped focus is known from the literature:
Wₛₜₐₜ=0.043(Tₘ−T₀)kμ(δ₁δ₂) (3)

In equation 3, Tₘ represents the melting temperature of the anode, T₀ is the ambient temperature, k is the thermal conductivity of the anode, δ1 and δ2 are the primary and secondary axes of the ellipse, and μ is a function of δ1 and δ2 that is known in the literature.

For a tungsten anode having a thickness significantly greater than δ1, a load capacity of 10 kW results for a segment having a length of 50 mm. This value can be increased by a factor of 5 by reducing the thickness of the anode, for example, by using a tungsten foil as the anode.

Therefore, cooling is advantageously accomplished using a liquid metal flowing perpendicular to the Y-direction. Given a heat convection coefficient for turbulent liquid metal of 10⁶ W m² K⁻¹ and an area of 50 mm2, this results in a temperature difference of ΔT=1000° for the absorption of thermal energy.

Even if the maximum X-ray power remains limited to about 10 kW, the potential simultaneous measurement of scattered radiation using 32 detector segments results in a signal that is improved by a factor of 32, which is why the possible loss of a factor of 5 due to reduced tube power is of subordinate importance.

The function of primary collimator/primary beam diaphragm arrangement P is to limit the angular range of the radiation from X-ray emitter Q in such a manner that the fundamental relationships of energy-dispersive X-ray diffraction (constant scattering angle for each detector segment) are satisfied. The angular variations in the plane of X-ray emitter Q and perpendicular thereto remain unchanged. Therefore, there is no need to modify primary collimator P in any way for the simultaneous multi-focus CXRS system according to the invention. Scatter collimator/secondary beam diaphragm arrangement S must meet several requirements; namely, it must establish a clear relationship between the Z-coordinate of the detector element and the depth position of the scattering voxel in the object, as expressed in equation 1. This is achieved by suitably limiting scattering angle θ of scattered radiation that reaches detector array D (see equation 1).

In contrast to the older multi-focus CXRS system, in the case of the invention, the scatter collimator must furthermore image the Y-coordinate of the currently active segment of radiation source Q onto the Y-coordinate of detector array D, according to the relationship in equation 2.

The angular range transmitted by scatter collimator S in the Y-direction into the X-Y plane is connected with the position resolution to be required at the location of radiation source Q. It is planned to activate anode segments having a length of 50 mm, which corresponds to a scattering voxel length in the object of about 30 mm. A suitable condition for the positional resolution to be required at radiation source Q is assumed to be ΔY_{Quelle}<10%×50 mm d.h. ΔY_{Quelle}<5 mm. Thus, the scattering voxels are defined with a positional accuracy of about 3 mm.

This condition is satisfied by the geometry of the older multi-focus CXRS system, where it is shown that the X-coordinate of the imaging slit that is closest to the object is 1345 mm (distance from Q₀).

The object space extends from 400 mm to 1050 mm, as measured from Q₀. Therefore, there is a space of at least 250 mm (1345 mm-1050 mm) between the end of the object space and the first imaging slit, which still leaves enough space for the conveyor belt.

It is only necessary to insert a one-dimensional multi-channel collimator between the end of the object region and the last imaging slit for the scattered radiation, as shown in FIG. 2. The height of this collimator in the X-direction is about 250 mm, resulting in a very effective radiation attenuation outside of its angular range. This effect is shown in FIG. 5 for a 250 mm high collimator with 100 μm thick steel walls. The oscillations are produced by the change in the number of walls that are penetrated by a beam (increases with increasing angle) and by the thickness of the walls (decreases with increasing angle).

Surprisingly, it turned out that both functions of the scatter collimator (that is, the selection of a segment of the anode and of a voxel depth in the object) can be combined in a two-dimensional collimator.

Scatter collimator S can be implemented in its entirety by a two-dimensional arrangement. The channels in the Z-direction are parallel to each other (see FIG. 2) and spaced apart according to the width of the detector elements (1.76 mm). The function of the scatter collimator in this direction is to connect the particular detector segment with a depth position in the object, in which a certain scattering voxel is to be analyzed. In the Y-direction, the channels converge toward point O, without this point physically playing a role. Two-dimensional collimators of this kind are known, for example, from U.S. Pat. No. 5,949,850 by Cha-Mei Tang and references cited therein, and commercially available (for example, Creative MicroTech, Internet page http://www.creatvmicrotech.com/). They are used, for example, in cone beam CT, to ensure that the detector is selectively irradiated by transmitted radiation and that the scattered radiation striking it is suppressed.

Detector array D must be energy-resolving for the simultaneous multi-focus CXRS system as before, it being preferred to use a germanium detector, which yields an energy resolution in the range LE/E^{˜}1.5% with a detection efficiency of about 75% at 100 keV. The physical dimensions of the crystal are around 10 mm in thickness as well as a useful diameter of 90 mm.

Detector array D must be segmented in the Z-direction, thus achieving the required position resolution in the X-direction, assuming a constant scattering angle θ. Then, the detector elements have a width of 1.765 mm. Altogether, there are 14 detector elements, which have a length of about 25 mm in the Z-direction. When looked at from the point of view of elementary geometry, the largest rectangle with a side length of 25 mm that can be circumscribed by a circle having a diameter of 90 mm is expressed by the formula:
A²=45²−12.52 (4)
where the side length is 2 A. This equation yields a value of 86 mm for 2A. Thus, this is the size of the rectangle for the image of the anode of the radiation source.

In contrast to the older multi-focus CXRS geometry, the detector array must also be segmented in the Y-direction. In this manner, scattering signals from radiation sources positions Q₀, Qₙ etc. can be recorded separately. In the older system, it was shown that the length of the detector elements in the Y-direction must be limited to about 10 mm to be able to achieve the desired constancy of the scattering angle (Aθ/θ^{˜}1.5%). Considering the slightly reduced length of the new system according to the invention (see below), this corresponds to a value of 8 mm now. Above (equation 4), an available segment length in the Y-direction of 86 mm was derived, which corresponds to about 11 separate focus position which can be resolved with 8 mm long segments.

If all 32 source segments are intended to be distinguishable, then 86/32=2.7 mm are available per source segment on the detector array. Alternatively, it is possible to distinguish 16 source segments at the detector array if each source segment occupies 5.7 mm. This is a good compromise between the efficiency with which an individual segment is used and the number of available segments. A view of the detector array along the X-axis is given in FIG. 6. There, a total of 14×16=224 elements are present, which represents a considerable challenge for the readout electronics of the detector array (see below).

From FIG. 2, it can be seen that, unlike the older multi-focus CXRS system, it is no longer necessary for point O to be implemented physically. Now, the detector is located at a distance X_{det} from Q₀, the distance satisfying the condition:
X_{det}=2150 mm×(1−86 mm/1550 mm) (5)

Equation 5 yields a value of about 2000 mm for X_{det}. Since the change in the position of the detector arrangement is only about 10% of the distance between the object and the detector array, it also follows that the geometric parameters (slit widths, width of the fan beam, etc.) of the older system remain valid. Chip-based counting electronics for segmented semiconductor gamma-ray detectors are known in the prior art (see Medipix 2 ASIC, http://medipix.web.cern.ch/MEDIPIX/). They are based on the measurement of the released charge that flows from the detector array via a connection (usually made of indium material) into an input stage of a CMOS chip which is divided into image elements and has simultaneous counting units in a 64×64 matrix, and which therefore has more channels than required for the detector proposed herein (16×14 channels). Each pixel on the readout chip has its own spectroscopic evaluation chain, including a charge-sensitive preamplifier, a filter (shaper), and a comparator having a 15-bit deep output buffer.

An alternative solution can be viewed on the Internet at the address http://gamma.radiology.arizona.edu/researchproiects/semiconductor.html.

According to this, the circuit is composed of three main components. A capacitive feedback transimpedance amplifier (CFTA) integrates the charge of the detector in a capacitor whose capacitance is much smaller than the input capacitance of a pixel and which therefore produces a high output signal. Secondly, a correlated double sample-and-hold circuit samples the output signal of the CFTA and stores the value in a capacitor, triggered by a reset signal. Finally, a multiplexer allows the capacitor voltages to be sequentially led off to a fast analog-to-digital converter (ADC), making it possible to accumulate 64×64×256 spectral channels. It is clear that in this case the count rate is limited to a greater extent.

These solutions do not quite offer the same performance of a discrete spectroscopic counter chain; however, this is not absolutely necessary in the CXRS application because there the energy resolution is modest (>1%).

In summary, the invention represents a variant of the simultaneous multi-focus CXRS system which can result in a significant improvement of the scanning speed, because all foci of the radiation source can be activated simultaneously. In the most advanced configuration, it completely eliminates the need for high-voltage electronics for addressing the cathode of the X-ray tube and, as a further advantage, it allows a modest reduction in the total length of the system. It results in a more complete recording of the object volume and, compared to the original concept, it reduces the risk of missing thin foils.

According to the invention, primary and secondary (scatter) collimators P,S can be implemented with little additional technical effort. The most significant changes relate to the detector array, which is now segmented two-dimensionally (for example, 32×14 elements), and to X-ray source Q, which advantageously has an advanced liquid metal cooling for dissipating the high thermal energy.

Due to the advantages of the simultaneous focus CXRS system according to the invention, its use appears to be useful where it is necessary to increase the scanning speed of the older multi-focus CXRS system or to improve the detection rate with the measuring time being constant.

1. A system for measuring the pulse transmission spectrum of X-ray quanta that are elastically scattered in an examination region (U) for containers, comprising a polychromatic X-ray emitter (Q) arranged on one side of the examination region (U) and a detector array (D) that is located on the other side of the examination region (U) and measures the energy of the scattered X-ray quanta, further comprising a primary beam diaphragm arrangement (P) and a secondary beam diaphragm arrangement (S) which lets only scattered radiation within a specific scattering angle range around the scattering angle—through to the detector array (D); the primary beam diaphragm arrangement (P) being arranged between the examination region and the X-ray emitter (Q), and the secondary beam diaphragm arrangement (S) being arranged between the examination region (U) and the detector array (D); the detector array (D) being equipped with means for processing the measured signals, and the primary beam diaphragm arrangement (P) letting pass through only X-rays that are essentially directed to point O; the point O lying on the Z-axis and defining the origin for a Cartesian coordinate system with X- and Y-axes; the primary beams propagating in the X, Z-plane and the conveying axis for the container to be examined running parallel to the Z-axis, characterized in that the detector array (D) has a 2-D segmentation in the Y, Z-plane and is located in front of the Z-axis; and in that the X-ray emitter (Q) is equipped with an extended anode that emits beams of radiation over its surface area either completely or partially simultaneously; and in that the secondary beam diaphragm arrangement (S) extends in the X-direction in such a manner that it converges to O and in the X, Z-plane at an angle—with respect to the X-axis such that the Y and X positions of the scattering voxel in the container are encoded onto the Y- and Z-dimensions of the detector array (D); and in that the X-ray emitter (Q) extends on a cylindrical surface around the Z-axis or linearly parallel to the Y-axis in the X,Y-plane.

2. The system as recited in claim 1, characterized in that the detector array (D) measures the scattered radiation produced in the examination region, is composed of semiconducting material such as germanium, cadmium zinc telluride (CdZnTe) and made up of rectangular segments having widths in the Y-direction of 0.5 mm to 2 mm and lengths between 5 and 15 mm in the Z-direction, and has a total number of segments between 50 and 500.

3. The system as recited in claim 1, characterized in that the detector array (D) is manufactured from a Ge single crystal having a diameter between 90 mm to 110 mm and has a rectangular useful region with a height of about 90 mm and a width of about 25 mm.

4. The system as recited in claim 1, characterized in that the detector array (D) is located at a distance of about 150 mm from the point O.

5. The system as recited in claim 2, characterized in that each segment of the detector array (D) has a means for pulse height spectrum analysis.

6. The system as recited in claim 1 characterized in that at point O, there is located either a detector (D) for measuring the radiation passing through, or a pinhole diaphragm via which the radiation that passes through is recorded on an X-ray sensitive detector line, the detector line being composed of a plurality (about 512) of detector elements, and in that the detector line is parallel to the Y-axis.

7. The system as recited in claim 1 characterized in that the secondary beam diaphragm arrangement is composed of a two-dimensional arrangement of blades which are made of X-ray absorbing material, such as Cu, in connection with which the imaginary extensions of the blades intersect at point O in the X-direction, have a length in the X-direction between 100 and 300 mm, and which extend parallel to each other in the X, Z-plane and at an angle between 0.02 and 0.06 radian with respect to the X-axis.

8. The system as recited in claim 1 characterized in that the primary beam diaphragm arrangement (P) is composed of a plurality of blades which are made of X-ray absorbing material, such as Cu, in connection with which the imaginary extensions of the blades intersect each other in the Z-axis, allow a beam divergence in the X, Y-plane of 0.2 to 0.6°, in particular, 0.4°, and which have a length in the X-direction between 100 and 300 mm and a maximum angle from the X-axis of ±20° in the X, Y-plane.

9. The system as recited in claim 1 characterized in that the extended anode has a length in the Y-direction of 1 to 2 m, in particular 1.5 m, over which length an electrode beam can be deflected, or the X-ray emitter (Q) is provided with a number of between 1 and 8 individual cathodes that are arranged side-by-side and can optionally be activated in a sequential pattern; the focal length on the anode being 200 to 1500 mm in the Y-direction and the effective focal width in the Z-direction being 0.2 mm;
and in that the dwell time for each activated focus position is 200 to 2000 μsec.

10. The system as recited in claim 1 characterized in that the fixed anode, which is composed of tungsten or gold, can be cooled with a coolant, such as water, oil, or liquid metal such as GaInSn.

11. The use of the system as recited in claim 1 for examining containers, such as baggage items, parcels, bags, containing explosives, weapons, or drugs.

12. The system as recited in claim 3, characterized in that each segment of the detector array (D) has a means for pulse height spectrum analysis.

13. The system as recited in claim 4, characterized in that each segment of the detector array (D) has a means for pulse height spectrum analysis.
